(19) United States
(12) Patent Application Publication
(10) Pub. No.: US 2005/0166591 A1
(43) Pub. Date: Aug. 4, 2005

(54) System for assisting the regeneration of depollution means integrated in an exhaust line of a heat engine

(75) Inventors: Piet Ameloot, Neuilly Sur Seine (FR); Pascal Folliot, Guyancourt (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: PEUGEOT CITROEN AUTOMOBILES SA, Velizy-Villacoublay (FR)

(21) Appl. No.: 11/048,121

(22) Filed: Feb. 2, 2005

(30) Foreign Application Priority Data
Feb. 3, 2004 (FR) 04 01013

(51) Int. Cl. F02D 41/00

(52) U.S. Cl. 60/599; 123/563

(57) ABSTRACT

The system for assisting the regeneration of depollution means (1) integrated in an exhaust line (2) of a heat engine (3) of a motor vehicle, by switching the engine between operation in lean mode and operation in rich mode in accordance with various parameters (7, 8) for controlling the operation of the engine, is characterized in that it comprises means (9) for measuring the temperature of the gases for supplying the engine and means (8) for correcting at least one parameter for controlling the operation of the engine in rich mode as a function of the measured temperature.

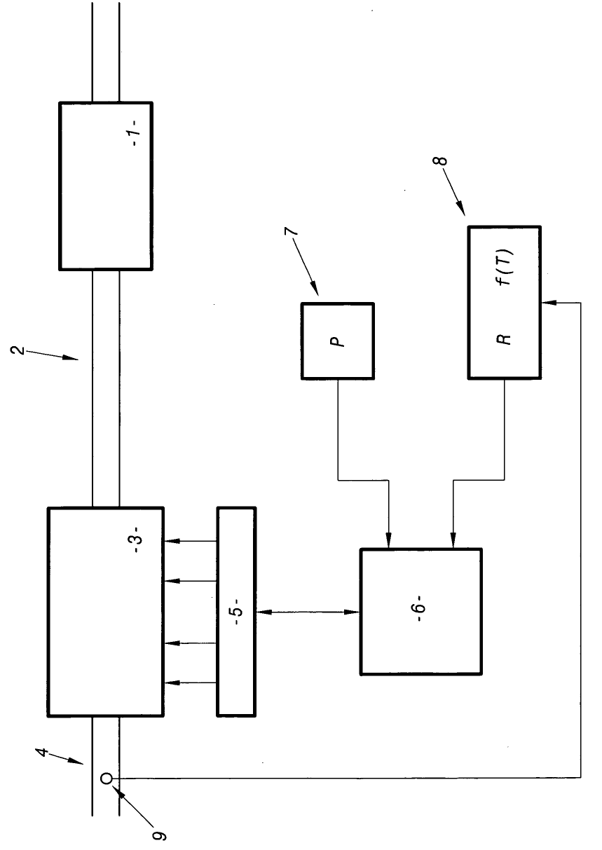

### TECHNICAL FIELD

The present invention relates to a system for assisting the regeneration of depollution means integrated in an exhaust line of a heat engine of a motor vehicle.

### BACKGROUND OF THE INVENTION

It is known that such depollution means may comprise, for example, a NOx trap which is a system for reducing the polluting emissions of the heat engines of motor vehicles.

The engine is then associated with means for controlling its operation in order to switch it between standard operation in lean mode and regeneration operation in rich mode, in accordance with various parameters for controlling the operation of the engine.

In the standard operating mode in lean mode, the NOx trap stores the nitrogen oxides and, when the trap is saturated, its regeneration is triggered by switching the engine to rich operating mode, for the purpose of removing the NOx from the store, in which mode the engine produces reducing agents, such as, for example, CO and HC.

This is conventionally effected by modifying at least one parameter for controlling engine operation, that is to say, at least one parameter relating to the injection of fuel into the engine (quantity, phasing, pressure, etc . . . ) and/or at least one parameter of the engine air supply loop (air flow rate, recycling, pressure of the turbocompressor, etc . . . ).

The various adjustments to those parameters enable predetermined performance objectives in terms of torque, pollutant emissions, noise, etc . . . to be achieved.

However, the calibration of the engine in rich operating mode is effected on the workbench under standard environmental conditions.

The object of the invention is to improve such a system in order to take into account variations in the environmental conditions.

### SUMMARY OF THE INVENTION

To that end, the invention relates to a system for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the compressed air between a compressor of a turbocompressor and an air-intercooler, which are associated with the engine.

The invention relates also to a system for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the air upstream of a compressor of a turbocompressor associated with the engine.

The invention relates also to a system for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the compressed air between an air-intercooler and the inlet for the recycling gases of the engine.

According to other features:
the depollution means comprise a NOx trap;
the means for measuring the temperature comprise a sensor for sensing the temperature in the environment of the vehicle;
the temperature sensor is formed in a flow meter;
the corrected parameter is a parameter for controlling the injection of fuel into the engine; and
the corrected parameter is a parameter for controlling the air supply loop of the engine.

### BRIEF DESCRIPTION OF DRAWING

The invention will be better understood on reading the following description which is given purely by way of example and with reference to the appended drawing which is a block diagram illustrating the structure and operation of a system in accordance with the invention.

### DESCRIPTION OF PREFERRED EMBODIMENT

The FIGURE shows a system for assisting the regeneration of depollution means which are denoted by the general reference 1 in this FIGURE and which are integrated, for example, in an exhaust line 2 of a heat engine 3 of a motor vehicle. The engine is also associated with air-supply means denoted by the general reference 4 and with means for controlling its supply of fuel, which are denoted by the general reference 5 and which comprise, for example, means having a common rail for supplying the injectors for injecting fuel into the engine cylinders.

The operation of those means is controlled by control means denoted by the general reference 6.

The depollution means comprise, for example, a NOx trap, and the control means 6 are in that case adapted to cause the operation of the engine to switch between operation in lean standard mode and operation in rich regeneration mode, in accordance with various parameters for controlling the operation thereof.

Those parameters are illustrated, for example, by references 7 and 8, respectively, in the FIGURE.

The parameters 7 are used to control the engine in lean operating mode while the parameters 8 are used to cause the engine to operate in rich regeneration mode.

In accordance with the invention, the system also comprises means for measuring the temperature of the gases for supplying the engine, which means are denoted by the general reference 9 in the FIGURE, and means for correcting at least one parameter for controlling the operation of the engine in rich mode, as a function of the measured temperature, in order to adapt that operation to the conditions encountered.

In accordance with the invention, the temperature of the gases for supplying the engine are taken into account in order to correct in rich mode one or more of the parameters for controlling the operation of the engine as a function of the actual temperature measured.

As has been indicated above, the parameter(s) may be one or more parameters for controlling the air supply loop of the engine, such as, for example, the air flow rate, the recycling of the exhaust gases, the pressure of the turbocompressor if the engine is associated with such a turbocompressor and/or one or more parameters for controlling the injection of fuel into the cylinders of the engine, such as, for example, the rate of flow, the phasing, or also the pressure, etc . . .

The means for measuring the temperature may for their part be suitable for measuring the temperature of the ambient environment of the vehicle, as measured, for example, in the line for the admission of air into the engine, by way of a sensor placed, for example, upstream of the compressor, if the engine is associated with a turbocompressor, or elsewhere on the vehicle, such as, for example, in a rear view mirror thereof.

However, the sensor may also be suitable for measuring the temperature of the compressed air between the compressor and the intercooler for the air for supplying the engine, or also the temperature of the compressed air between the air-intercooler and the inlet where the recycling gases enter the engine.

This therefore permits correction of the parameters for controlling the operation of the engine in rich operating mode in order to optimize the regeneration stage of the depollution means.

The parameters 8 used may then be in the form of a preestablished map of values of the parameter(s) as a function of the temperature, enabling the corresponding parameter(s) to be obtained as a function of the measured temperature.

Of course, yet other embodiments may be envisaged.

Thus, for example, the means for measuring the temperature may be formed, for example, in a flow meter.

1. System for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the compressed air between a compressor of a turbocompressor and an air-intercooler, which are associated with the engine.

2. System for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the air upstream of a compressor of a turbocompressor associated with the engine.

3. System for assisting the regeneration of depollution means integrated in an exhaust line of a heat engine of a motor vehicle, by switching the engine between operation in lean mode and operation in rich mode in accordance with various parameters for controlling the operation of the engine, characterized in that it comprises means for measuring the temperature of the gases for supplying the engine and means for correcting at least one parameter for controlling the operation of the engine in rich mode as a function of the measured temperature, and in that the means for measuring the temperature comprise a sensor for sensing the temperature of the compressed air between an air-intercooler and the inlet for the recycling gases of the engine.

4. System according to claim 1, wherein the depollution means comprise a NOx trap.

5. System according to claim 1, wherein the means for measuring the temperature comprise a sensor for sensing the temperature in the environment of the vehicle.

6. System according to claim 1, wherein the sensor for sensing the temperature is formed in a flow meter.

7. System according to claim 1, wherein the corrected parameter is a parameter for controlling the injection of fuel into the engine.

8. System according to claim 1, wherein the corrected parameter is a parameter for controlling the air supply loop of the engine.

9. System according to claim 2, wherein the depollution means comprise a NOx trap.

10. System according to claim 2, wherein the means for measuring the temperature comprise a sensor for sensing the temperature in the environment of the vehicle.

11. System according to claim 2, wherein the sensor for sensing the temperature is formed in a flow meter.

12. System according to claim 2, wherein the corrected parameter is a parameter for controlling the injection of fuel into the engine.

13. System according to claim 2, wherein the corrected parameter is a parameter for controlling the air supply loop of the engine.

14. System according to claim 3, wherein the depollution means comprise a NOx trap.

15. System according to claim 3, wherein the means for measuring the temperature comprise a sensor for sensing the temperature in the environment of the vehicle.

16. System according to claim 3, wherein the sensor for sensing the temperature is formed in a flow meter.

17. System according to claim 3, wherein the corrected parameter is a parameter for controlling the injection of fuel into the engine.

18. System according to claim 3, wherein the corrected parameter is a parameter for controlling the air supply loop of the engine.
